(19) United States
(12) Patent Application Publication
(10) Pub. No.: US 2003/0031531 A1
(43) Pub. Date: Feb. 13, 2003

(54) Lock nut arrangement

(76) Inventor: James H. Aldridge, Harrisville, MI (US)

Correspondence Address: Irving M Weiner, Weiner & Burt, 635 N US 23, PO Box 186, Harrisville, MI, 48740, US

(21) Appl. No.: 09/856,524

(22) PCT Filed: Mar. 13, 2001
(86) PCT No.: PCT/US01/07862

(51) Int. Cl. F16B 37/08

(52) U.S. Cl. 411/432

(57) ABSTRACT

A lock nut unit formed of first and second generally C-shaped nut members which are joined together to allow limited axial movement and free rotation relative to one another. The nut members each have a slot projecting outwardly from a central bore portion. The slot has its major side walls non-parallel to each other to form an outwardly diverging slot to aid in placing the unit on a threaded rod. The unit may be radially installed on the threaded rod and locked thereon by rotating the nut members relative to one another.

The invention relates to a lock nut arrangement. More particularly, the invention relates to an improved locknut arrangement which can be initially positioned on and around a threaded rod by relative transverse movement therebetween, and thereafter lockingly secured relative to the rod by relative rotation of less than one revolution.

### BACKGROUND OF INVENTION

Many applications require the use of lock nut arrangements for permitting a fixed positional relationship to be established between a threaded rod and an object or article. The conventional lock nut arrangement involves threading a first nut along the rod until reaching a position of abutting or stationary engagement with the article, and threading a second nut along the rod until it snugly abuts the first nut so as to prevent loosening of the latter. This conventional arrangement, which having been utilized for many years, nevertheless possesses well-recognized disadvantages. For example, this arrangement requires the use of two separate nuts. Further, each nut must be threaded along, in many instances, a very long axial extent of the threaded rod before reaching the desired locking position. This is obviously a laborious and time consuming operation, and in many instances it is impossible to provide proper access for the nuts on the rod, particularly in situations where the lock nuts are desired for disposition on an intermediate section of the rod.

In an attempt to provide an improved lock nut arrangement, variations have been devised which involve the use of a nut employing a captive spring, such as a gripping spring or the like. Such springs are intended to create a gripping engagement between the object and the nut, and to maintain sufficient tension to prevent loosening of the nut. Such arrangements have also possessed similar disadvantages because they must be threaded over the free end of the rod and then threaded to the position of use.

Others have made two-piece lock nuts which would be installed transversely on a section of threaded rod. These devices are impractical because the two nuts are confusingly similar when separated. Such devices are shown in Rox U.S. Pat. No. 2,355,679. Others have used a single C-shaped nut as shown in Rox U.S. Pat. No. 2,374,309 and DeLong U.S. Pat. No. 1,375,781. However these devices unevenly load the rod threads and must rely on function or a C-shaped washer to prevent radial disengagement.

Accordingly, it is an object of this invention to provide an improved lock nut arrangement which overcomes the disadvantages associated with the conventional arrangements.

More specifically, it is an object of this invention to provide an improved lock nut arrangement which can be be moved transversely into engagement with a threaded rod closely adjacent the desired position of use, whereby it is unnecessary to thread the lock nut arrangement onto the rod over the free end thereof.

A further object and advantage of this improved lock nut arrangement is its ability, when positioned on a threaded rod, to be moved into a locking position by relative rotation of less than one revolution with respect to the rod.

A further object of the invention is to provide an improved lock nut arrangement which, in addition to the advantages explained above, is constructed of two nuts which are permanently joined together by a connection which permits relative rotation and limited axial displacement between the two nuts, whereby there is provided an integrated and unitary assembly which can be consistently manufactured and used in a manner similar to a single nut.

Other objects and purposes of the invention will be apparent to persons familiar with structures of this general type upon reading the following specification and accompanying drawings.

### SUMMARY OF THE INVENTION

The improved lock nut arrangement of this invention employs first and second nut members which are disposed closely axially adjacent one another and have an axially interfitting rib-and-groove arrangement therebetween. This interfitting rib-and-groove arrangement permits unrestricted relative rotation of the first and second nuts with respect to one another in concentric relationship to the common longitudinal axis of the nut. This interfitting rib-and-groove structure prevents axial separation of the nuts so that they remain permanently joined together to function as a unitary arrangement. The nuts have threaded openings extending axially therethrough, and a non-parallel slot projecting from the periphery inwardly for communication with the respective threaded opening. The slot has a varying non-constant width which tapers outwardly from the threaded opening. The radial centerline of the slot intersects the axis of the threaded opening so that the threaded opening, due to its intersection with the slot, defines an arcuate threaded wall which extends through an angle of about 180°. With the slots aligned one over the other, the nut arrangement is positioned so that the mouths of the slots are directly adjacent the threaded rod at the desired point of use, whereupon the nut arrangement is moved transversely on the rod so that the threaded rod engages the arcuate threaded walls associated with the two nut members. Thereafter, one nut member is rotated relative to the other nut member through a fraction of a revolution, such as one-half revolution, thus causing the slots to be non-aligned so that the nut arrangement totally surrounds and captivates the rod. This relative rotation, and the threaded engagement between the nut and the rod, causes the two nuts to be relatively axially moved toward one another and to effect a compressive locking engagement between the two nuts. Removal of the lock nut arrangement can be easily effected by reversing the above-described sequence.

### BRIEF DESCRIPTION OF THE DRAWINGS

FIG. 1 is a top view of a preferred embodiment of the lock nut arrangement of this invention, the nut being illustrated in its released position.

FIG. 2 is a central sectional view of the lock nut as taken substantially along line 2-2 in FIG. 1.

FIG. 2A is an exploded sectional view illustrating the rib-and-groove structure which cooperates between the two nuts of the lock nut arrangement.

FIG. 3 is a front view of the lock nut arrangement shown in FIG. 1.

FIG. 4 is a top view similar to FIG. 1 but showing the nut arrangement in its locked position.

FIG. 5 is a sectional view taken substantially along line 5-5 in FIG. 4.

Certain terminology will be used in the following description for convenience in reference only, and will not be limiting. For example, the words “upwardly”, “downwardly”, “rightwardly” and “leftwardly” will refer to directions in the drawings to which reference is made. The words “inwardly” and “outwardly” will refer to directions toward and away from, respectively, the geometric center of the nut assembly and designated parts thereof. Said terminology will include the words specifically mentioned, derivatives thereof, and words of similar import.

### DETAILED DESCRIPTION OF A PREFERRED EMBODIMENT

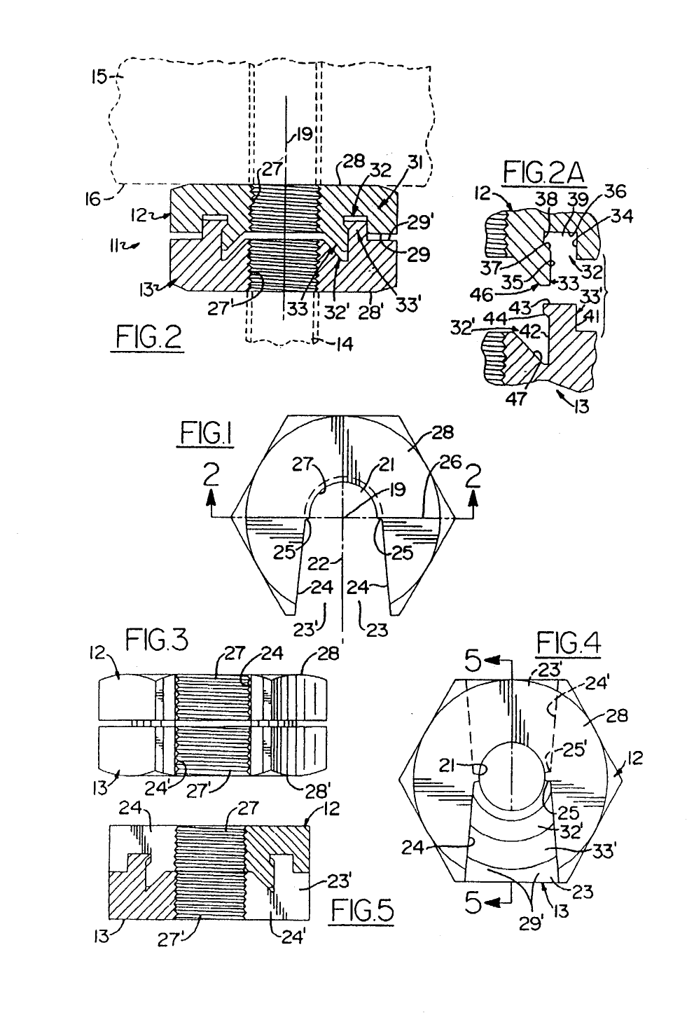

Referring to FIGS. 1-5, there is illustrated a preferred embodiment of a lock nut unit or arrangement according to the present invention. This lock nut unit 11 includes first and second nut members 12 and 13, respectively, which members will hereinafter be respectively referred to as the upper and lower members for convenience in description relative to their position in the drawings. The lock nut unit 11 is illustrated in FIG. 2 in association with a threaded rod 14 projecting from an object or article 15 to permit the lock nut arrangement to cooperate with a surface 16 on the article. The threaded rod 14 and article 15 are represented by dotted lines in FIG. 2.

Considering the first or upper nut member 12, it has a central opening 21 therethrough concentric with the central longitudinal axis 19 of the nut members. A slot 23 is formed in the nut member 12, which slot extends axially through the complete thickness of the nut member and projects radially inwardly from the outer periphery thereof for communication with the central opening 21. This slot 23 extends radially of the nut member so that its centerline 22 intersects the axis 19. The slot 23 is defined between non-parallel side walls 24 which diverge from a distance or slot width which is at least equal to and preferably is just slightly greater than the diameter of the threaded rod 14 and threaded opening 21 to a distance or slot width which is greater than said diameter. Each side wall 24 is preferably tapered outwardly approximately 5° relative to slot centerline 22 to make installation of unit 11 on rod 14 easier. Side walls 24 project radially inwardly of the nut to a point which is close to but preferably just short of the central diametral plane 26, whereupon these side walls 24 terminate in inner walls or shoulders 25 which slope inwardly for communication withthe side wall 27 defining the opening 21. The provision of this slot 23, and its communication with the central opening 21 being of an arcuate configuration extending through a minimum angle of at least about 180°, with this arcuate side wall 27 preferably extending through an arcuate angle which just slightly exceeds 180°, such as about 190° to about 200°. Angles less than 180° will work; however, strength will be unnecessarily reduced.

The nut member 12 has an annular flat surface 28 on the upper or outer end thereof, and has a similar annular flat surface 29 on the lower or inner end thereof.

The second or lower nut member 13 possesses substantially the same structure as the upper nut member 12 as described above, and hence corresponding parts of the lower nut member 13 have been designated by the same reference numerals used to designate the upper nut member 12 except for the addition of a prime (′) thereto.

A connecting structure 31 is provided to ensure that the nut members 12 and 13 are permanently coupled together to prevent their complete separation. Structure 31 permits unrestricted relative rotation between the nut members and permits limited axial displacement therebetween. Structure 31 basically comprises a cooperating rib-and-groove arrangement, and preferably comprises two such arrangements disposed concentrically one within the other.

As illustrated by FIGS. 2 and 2A, structure 31 includes an annular recess or groove 32 which is formed in the upper nut member 12. This annular groove 32 projects axially upwardly into the nut member from the lower surface 29 thereof, and is adapted to receive therein an annular rib 31′ which projects axially upwardly from the upper surface 29′ of member 13. Rib 33′, as defined between side walls 41 and 42, is substantially equal to but preferably slightly less than the radial width of the groove 32 as defined between the annular side walls 34 and 35. Rib 33′ has a nose or projection 43 adjacent the free end thereof, which nose 43 projects sidewardly, that is, radially inwardly in relation to the axis 19.

The connecting structure also includes an annular rib 33 which is integrally formed on the nut 12 concentric to the groove 32, which rib 33 projects axially downwardly from the lower surface 29. Rib 33 projects axially into an annular groove or recess 32′ which is formed in nut 13 concentric to rib 33. Groove 32′ projects axially downwardly from the upper end surface 29′.

Groove 32 is defined between outer and inner annular side walls 34 and 35, respectively. Outer side wall 34 projects axially upwardly from the lower surface 29 and terminates at a substantially flat bottom wall 36 of the groove. Inner side wall 35 does not project the full axial depth of the groove, but rather projects only partially of the groove and terminates at a sloped annular side wall or shoulder 37, the latter being sloped radially inwardly toward the central axis 19 as it continues to project axially upwardly. Shoulder 37, at its other end, terminates in an inner annular side wall 38 which is concentric with the side wall 35 but spaced radially inwardly thereof. This inner side wall 38 then projects axially upwardly for joining with the flat bottom wall 36. This results in the slot 32, adjacent the inner or closed end thereof, having a radially inwardly projecting nose or undercut portion 39, whereby the slot 32 has a substantially L-shaped cross section.

Rib 33′, which projects into and is confined within groove 32, is defined between annular outer and inner side walls 41 and 42, respectively, and is positionable within the nose portion 39 of the groove. Nose 43 has a sloped wall or shoulder 44 on the underside thereof. The axial dimension or thickness of nose 43 is less than the axial height of the groove nose portion 39 to provide axial clearance in the groove, as illustrated by FIG. 2, to permit limited axial displacement between the nut members 12 and 13.

Rib 33 has an outer annular wall 35 which also defines the inner annular wall of the groove 32. Rib 33 also has a sloped inner wall 46 which projects axially downwardly and slopes radially outwardly toward the free end of the rib. The opposed groove 32′ is similarly configured in that it has an inner wall 47 which is sloped downwardly and outwardly as it projects axially inwardly of the nut, whereby the opposed walls 46 and 47 are of similar slopes. Groove 32′ has an outer annual wall which is defined by the wall 42.

With nuts 12 and 13 fitted together as illustrated by FIG. 2, rib 33′ projects axially into groove 32 and is freely rotatably supported therein. Similarly, rib 33 projects into groove 32, and is freely rotatably supported therein. Due to the provision of nose 43, and its confinement within the nose portion 39 of the groove 32, the surface 44 abuts the shoulder 37 and prevents axial separation of the nut members, whereby the nut members remain permanently connected together to form a unitary arrangement for convenience in handling. Nose 44 has an axial dimension which is less than the height of the groove nose portion 39, and hence the nuts 12 and 13 have a permissible but limited axial displacement therebetween. When the surface abuts the shoulder 37 as illustrated by FIG. 2, the nuts 12 and 13 are in a spaced relationship corresponding to the released or unlocked position of the lock nut arrangement. In this position, the opposed surfaces 29 and 29′ are spaced apart, the upper surface of rib 33′ is spaced downwardly from the bottom wall 36 of groove 32, and the opposed tapered walls 46 and 47 are spaced apart. In this embodiment, this spacing preferably, but not necessarily, corresponds to an axial dimension equal to approximately one-third to one-half of an axial thread pitch.

Nuts 12 and 13 can, be moved axially toward one another until the latter-mentioned surfaces substantially abut one another, this latter position being illustrated by FIG. 5 corresponding to the locked position of the lock nut arrangement. Preferably, the two nut members will have threaded arcuate side walls 27 and 27′ of approximately the same axial length as shown. If the nuts have significantly different thread contact areas, excessive stress limitations would limit the maximum applied torque on the two nuts. The two nuts will also preferably have equal axial height on their peripheral edge as shown to provide ample contact area for a wrench or the like for tightening same.

To utilize the lock nut arrangement 11, the arrangement is initially positioned such that the slots 23 and 23′ are aligned directly one over the other substantially as illustrated by FIGS. 1 and 3. The arrangement 11 is then positioned directly adjacent the threaded rod 14 at the desired location, and then moved transversely relative to the rod. Rod 14 moves radially inwardly through the slots 23, 23′ for engagement with the threaded walls 27, 27′. To ensure that the threaded walls 27 and 27′ properly engage with the external thread on the rod 14, the nuts 12 and 13 are initially maintained in their axially spaced relationship as illustrated by FIG. 1. Because the threaded walls 27, 27′ individually engage the external thread of the rod 14, the nuts will properly align themselves with the rod so that their respective threads mate (i.e., in proper phase). With the slots of the nuts aligned and the threads engaged in phase with the rod, the surfaces 29 and 29′ will be between ⅙ to ½ a thread pitch apart, preferably ½ of a thread pitch.

Once the lock nut arrangement has been moved transversely into engagement with the threaded rod 14 so the threads are in phase, and assuming that the upper surface 28 on the upper nut is substantially engaged with the bottom surface 16 of the object 15, then the upper nut 12 is maintained in a non-rotatable condition, and the lower nut 13 is manually rotated through approximately one-half revolution toward the upper nut 12. This one-half revolution of the lower nut 13, and its engagement with the threaded rod 14, causes lower nut 13 to advance axially upwardly along threaded rod 14 through an axial distance equal approximately one-half the thread pitch. The nuts may be designed so that ⅙ to ½ of a rotation is required before the two surfaces 29 and 29′ engage one another. A preferred distance is ⅓ of a rotation because after the two surfaces contact one another the nuts are typically tightened further within the elastic limits of the nuts the rod. The ⅓ dimension results in a ½ rotation orientation as shown in FIG. 4 when fully tightened.

After this one-half revolution of the lower nut 13, the rib 33′ has advanced upwardly into the groove 32 throughout substantially its full depth, and simultaneously the rib 33 has relatively moved downwardly into the groove 32′ to cause the opposed tapered surfaces 46 and 47 to securely wedgingly contact one another and effect a secure and rigid connection of the nuts 12 and 13. Within this latter secured and locked position, the slots 23, 23′ are oriented in substantially diametrically opposed relationship, as illustrated by FIGS. 4 and 5, and this results in the nut creating a secure threaded engagement with the rod 14 over a full 360° angular extent.

When release of the lock nut is desired, the reverse sequence is employed in that the lower nut 13 is reversely rotated through one-half revolution so the slots 23, 23′ are again aligned, following which the complete nut arrangement can be moved transversely relative to the rod to disengage the latter.

With the lock nut unit 11, the nuts 12 and 13 always remain joined together to permit handling and manipulating thereof in a manner similar to that associated with a single nut, with two hands being required for operation only when it is necessary to relatively rotate the nuts into locking or unlocking position.

Although particular a preferred embodiment of the invention have been disclosed in detail for illustrative purposes, it will be recognized that variations or modifications of the disclosed apparatus, including the rearrangement of parts and steps, lie within the scope of the present invention.

1. A lock nut comprising:
first and second generally C-shaped nut members, each having an internally threaded axial bore portion and a slot projecting from said bore portion, said slot having its major side walls disposed non-parallel to each other to form a slot which diverges outwardly from said bore portion, and said nut members having connection means for axially connecting the nut members to permit free relative rotation and limited axial displacement therebetween while preventing the total separation thereof.

2. The lock nut of claim 1, wherein said threads of the first and second members are in phase when said nuts have their slots aligned and are axially separated from one another ⅙ to ½ of a thread pitch.

3. The lock nut of claim 1, wherein said first and second nut members are provided with a concentric groove on one member and a corresponding concentric rib and the other member for telescopically corresponding with one another to limit radial movement therebetween while allowing a free rotation about the bore axis.

4. The lock nut of claim 3, wherein said connection means includes an undercut groove formed in one of said nut members and a corresponding concentric nose for cooperating therewith formed in the other nut member to thereby limit axial displacement therebetween preventing complete separation.

5. The lock nut of claim 1, wherein said threaded axial bore of both nut members have approximately equal axial thread lengths.

6. The lock nut of claim 1, wherein said first and second nut members are provided with a peripheral edge having means for gripping the nut members formed thereon.

7. The lock nut of claim 1, wherein said first and second nut members have approximately equal axial lengths at the peripheral edge.

8. The lock nut of claim 1, wherein:
said threads of the first and second nut members are in phase when said nuts have their slots aligned and are axially spaced ⅙ to ½ of a thread pitch; and
said first and second nut members have a groove on one nut member and a corresponding rib on the opposite nut member which telescopically interlock with one another.

9. The lock nut of claim 1 wherein the first and second members may be rotated relative to one another with a threaded rod while cooperating between an unlock position where their respective slots are aligned, and a lock position where the nut members axially contact one another, have their threads generally aligned and in phase.

10. The lock nut of claim 1, wherein each said major side wall of said slot tapers outwardly from said axial bore portion approximately 5° relative to a centerline of said slot.

11. The lock nut of claim 2, wherein each said major side wall of said slot tapers outwardly from said axial bore portion approximately 5° relative to a centerline of said slot.

12. The lock nut of claim 3, wherein each said major side wall of said slot tapers outwardly from said axial bore portion approximately 5° relative to a centerline of said slot.

13. The lock nut of claim 4, wherein each said major side wall of said slot tapers outwardly from said axial bore portion approximately 5° relative to a centerline of said slot.

14. The lock nut of claim 5, wherein each said major side wall of said slot tapers outwardly from said axial bore portion approximately 5° relative to a centerline of said slot.

15. The lock nut of claim 8, wherein each said major side wall of said slot tapers outwardly from said axial bore portion approximately 5° relative to a centerline of said slot.

16. The lock nut of claim 9, wherein each said major side wall of said slot tapers outwardly from said axial bore portion approximately 5° relative to a centerline of said slot.
